(19) United States
(12) Patent Application Publication
(10) Pub. No.: US 2011/0007046 A1
(43) Pub. Date: Jan. 13, 2011

(54) SMART DISPLAY DEVICES

(75) Inventors: Yu-Hsiang Tsai, Changhua County (TW); Wei-Yuan Cheng, Taipei County (TW); Kuo-Lung Lo, Taipei County (TW); Hsin-Hung Lee, Taipei County (TW); Shu-Wei Kuo, Taipei County (TW)

Correspondence Address: QUINTERO LAW OFFICE, PC, 615 Hampton Dr, Suite A202, Venice, CA, 90291, US

(73) Assignee: INDUSTRIAL TECHNOLOGY RESEARCH INSTITUTE, HSINCHU (TW)

(21) Appl. No.: 12/692,548

(22) Filed: Jan. 22, 2010

(30) Foreign Application Priority Data
Jul. 7, 2009 (TW) TW098122918

(51) Int. Cl. G09G 5/00; G02B 26/00

(52) U.S. Cl. 345/207; 359/291

(57) ABSTRACT

Smart display devices are presented. The smart display device includes an electrowetting panel, a photo-detector device, and a panel driving control device, wherein the photo-detector device detects environmental light such that the electrowetting panel is driven by the panel driving control device accordingly. The electrowetting panel has an array of pixels, wherein each pixel includes a first substrate and an opposing second substrate with a polar fluid layer and a non-polar fluid layer interposed between the first and second substrates. A first electrode is disposed on the first substrate. A second electrode is disposed on the second substrate. A hydrophilic bank structure is disposed between the first and the second substrates.

### CROSS REFERENCE TO RELATED APPLICATIONS

This application is based upon and claims the benefit of priority from a prior Taiwanese Patent Application No. 098122918, filed on Jul. 07, 2009, the entire contents of which are incorporated herein by reference.

### BACKGROUND OF THE INVENTION

1. Field of the Invention

The invention relates to smart display devices, and in particular to, electrowetting type smart display devices.

2. Description of the Related Art

Smart display devices have been used in applications such as electrochromic windows, polymer dispersed liquid crystal (PDLC) displays, and electrophoresis displays. However, a technical bottleneck is reached, in improving smart display device characteristics, such as high light source utilization, high color purity (chromaticity), lower cost and lower power consumption.

Smart display devices may locally and regionally have optical modulation functions, such as partial shielding effect or real-time information display. Note that electrowetting displays may be used as indoor or outdoor billboards due to characteristics of transmission and reflection.

Smart display devices based on electrochromic materials and liquid crystal (LC) materials have been disclosed. For example, Taiwan patent No. 94138831, the entire contents of which are incorporated herein by reference, discloses “electrochromic mirrors or windows for displaying information”. Electrochromic liquid crystal materials are used in electrochromic mirrors or windows.

Meanwhile, related material technologies such as polymer dispersed liquid crystals (PDLC) and polymer-stabilized cholesteric textures (PSCT) have been disclosed, in U.S. Pat. No. 5,691,795 and Taiwan patent No. 89106299.

### BRIEF SUMMARY OF THE INVENTION

An embodiment of the invention provides a smart display device, comprising an electrowetting panel with an array of multiple pixels, a photo-detector device, and a panel driving control device, wherein the photo-detector device detects environmental light and the electrowetting panel is driven by the panel driving control device. Each pixel comprises a first substrate and an opposing second substrate with a polar fluid layer and a non-polar fluid layer interposed between the first and second substrates, wherein the non-polar fluid layer directly contacts the first substrate. A first electrode is disposed on the first substrate and a second electrode is disposed on the second substrate. A hydrophilic bank structure is disposed between the first and the second substrates.

Another embodiment of the invention provides a smart display device, comprising an electrowetting panel with an array of multiple pixels, a photo-detector device, a panel driving control device, and a retrievable reflective plate, wherein the photo-detector device detects environmental light and the electrowetting panel is driven by the panel driving control device. The retrievable reflective plate is a double layered reflective plate respectively set on both sides of the electrowetting panel. Each pixel comprises a first substrate and an opposing second substrate with a polar fluid layer and a non-polar fluid layer interposed between the first and second substrates, wherein the non-polar fluid layer directly contacts the first substrate. A first electrode is disposed on the first substrate and a second electrode is disposed on the second substrate. A hydrophilic bank structure is disposed between the first and the second substrates.

### BRIEF DESCRIPTION OF THE DRAWINGS

The invention can be more fully understood by reading the subsequent detailed description and examples with references made to the accompanying drawings, wherein:

FIG. 1 is a cross section illustrating an electrowetting panel structure in a smart display device according to an embodiment of the invention;

FIG. 2 is a schematic view illustrating an embodiment of smart display devices with an embedded photo-detector;

FIGS. 3A and 3B are block diagrams schematically illustrating another embodiment of the smart display device with plug-in photo-detectors;

FIG. 4 shows a schematic view of an exemplary embodiment of partially shielding a light-traceable electronic curtain;

FIG. 5 shows a schematic view of another exemplary embodiment of partially shielding a light-traceable electronic curtain;

FIGS. 6A and 6B are schematic views illustrating an exemplary embodiment of the smart display device applied as a context window;

FIGS. 7A to 7C are schematic views illustrating an exemplary embodiment of the smart display device having a double-sided reflective plate structure;

FIGS. 8A to 8C show schematic views of another embodiment of the smart display device with a double-sided retrievable reflector mechanism;

FIGS. 9A and 9B are schematic views illustrating an example of the smart display device of FIG. 8A being applied in a reflective display; and

FIG. 10 is a schematic view illustrating another application example of the smart display device of FIG. 8A being applied in a reflective display.

### DETAILED DESCRIPTION OF THE INVENTION

It is to be understood that the following disclosure provides many different embodiments, or examples, for implementing different features of various embodiments. Specific examples of components and arrangements are described below to simplify the present disclosure. These are merely examples and are not intended to be limiting. In addition, the present disclosure may repeat reference numerals and/or letters in the various examples. This repetition is for the purpose of simplicity and clarity and does not in itself indicate a relationship between the various embodiments and/or configurations discussed. Moreover, the formation of a first feature over or on a second feature in the description that follows may include embodiments in which the first and second features are formed in direct contact or not in direct contact.

Electrowetting displays have fast response, excellent color rendering and low power consumption. Moreover, electrowetting displays comprise standard materials, thus fabrication costs are relatively low. As such, when electrowetting displays are applied to smart displays, the cost of smart displays is relatively decreased. Furthermore, electrowetting displays may comprise movable reflectors according to display characteristics, having reflective mode and transmissive mode switches.

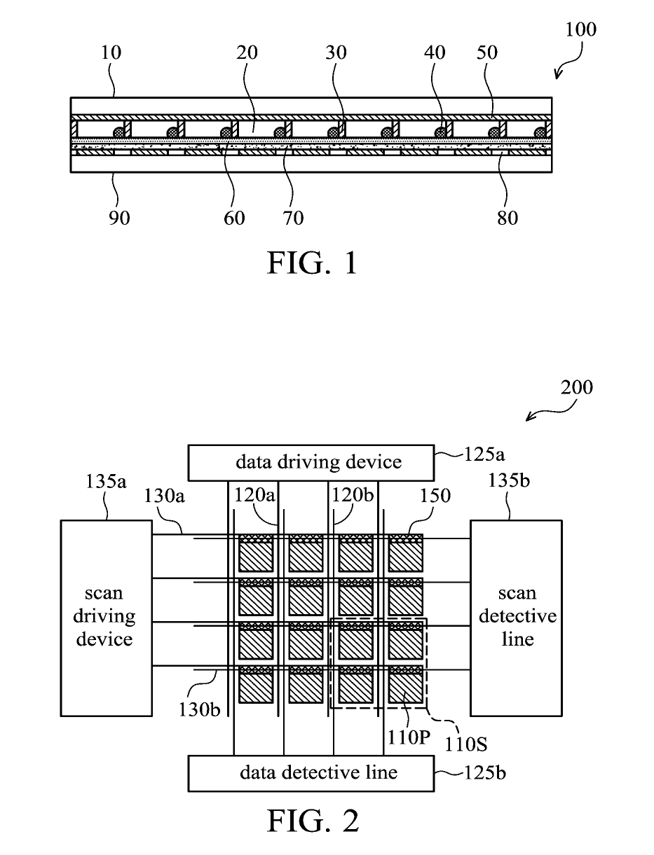

FIG. 1 is a cross section illustrating an electrowetting panel structure in a smart display device according to an embodiment of the invention. The electrowetting panel structure can be applied to embodiments of smart display devices. Large area smart display devices normally adopt a high barrier bank structure to isolate pixels and prevent vertical fluid overflow. Referring to FIG. 1, an electrowetting panel structure 100 includes a first substrate 10 and a second substrate 90 opposing to each other. A polar fluid layer 20 and a non-polar fluid layer 40 are interposed between the first and second substrates, wherein the non-polar fluid layer directly contacts the first substrate. A first electrode layer 50 is disposed on the first substrate 10. A second electrode layer 80 including pixel electrodes and an array of thin film transistors is disposed on the second substrate 90. A hydrophilic bank structure 30 is interposed between the first and the second substrates 10 and 90. In one embodiment, a surface of the second electrode layer 80 is hydrophobic. In another embodiment, the electrowetting panel structure 100 further includes a high-k dielectric layer 70 disposed on the second electrode layer 80 and a hydrophobic layer 60 disposed on the high-k dielectric layer 70. It should be understood that both the first substrate and the opposing second substrate are assembled through the hydrophilic bank structure to block the non-polar fluid layer and prevent vertical fluid overflow of the pixels.

One embodiment of the invention applies the electrowetting display structure in a light modulation mechanism. The electrowetting display structure is fabricated between two glass substrates. Further, in order to implement large scale application, a high barrier bank structure is used. After a non-polar fluid layer is formed on the hydrophobic pixel surface, a transparent polar fluid is filled between the opposing two glass substrate. Colors of the non-polar fluid layer can vary according to actual demands. A black color can be chosen as a shield, while different color oils can be filled in sub-pixels to achieve full color display.

The substrates used in smart display devices can be active and passive. During operation, the two different modes such as the shielding mode and the reflective mode can be switched. Under the shielding mode, an automatic light traceable shielding mode or a self-definition shielding mode can be selected. Automatic light traceable shielding is configured with photo diodes embedded in the pixel array or photo-sensitive material or photo-detective materials such as organic photo-conductor (OPC). Meanwhile, a suitable circuit is applied to implement control of the pixel switches. When self-definition shielding is chosen, the optical detective signal is switched off, and the light shield region is defined by users or desirable display information.

FIG. 2 is a schematic view illustrating an embodiment of smart display devices with an embedded photo-detector. In order to achieve light shading effect varied with light intense regions, the smart display devices use embedded photo-detectors disposed in the pixel array of the electrowetting display. Namely, an additional set of data lines and scan lines for detecting optical signals detects a voltage variation or a resist variation of the photo-sensitive material. Through the circuit on the control board, the detected data are processed and output to drive corresponding components of the smart display devices.

Referring to FIG. 2, a smart display device 200 includes an electrowetting display panel 100 having an array of pixels 110P. Among the pixels 100P, a set of a first data line 120a and a first scan line 130a electrically connect to a first data driving device 125a and a first scan driving device 135a respectively to drive a pre-determined pixel 110P. In one embodiment, a photo-detector 150 is disposed in each pixel 110P. Among the pixels 100P, an additional set of a second data line 120b and a second scan line 130b electrically connect to a first data detective device 125b and a first scan detective device 135b respectively to detect a pre-determined pixel 110P. In another embodiment, the electrowetting display panel 100 includes a plurality of sub-regions, wherein each of the sub-pixels has one photo-detector and multiple pixels 110P. By arranging the photo-detector and the display glass, signals acquired by the photo detective materials are detected by one set of the scan and signal line and feed back to a driving system. In one embodiment, the photo-detector device can be a photo-sensitive material embedded within each pixel. The photo-sensitive material can be an organic photo-conductor (OPC) or a semiconductor PN junction.

It should be noted that the electrowetting panel structure can include an additional set of a second data line and a second scan line electrically connecting to a data detective device and a scan detective device respectively to detect a voltage variation or a resist variation of the photo-sensitive material. In one embodiment, merely one photo-sensitive material exists in each pixel. In another embodiment of the invention, the electrowetting panel comprises a plurality of sub-regions 100S, wherein several sub-pixels correspond to one photo-sensitive material in each sub-region. Moreover, the panel driving control device comprises a driving control board and a micro-controller, wherein the electrowetting panel comprises a set of a scan detective line and a data detective line extending to one end of the photo-detector device. When exposed to light, the photo-detector device generates a signal which feeds back to the driving control board, where the micro-controller determines a desirable pixel for displaying.

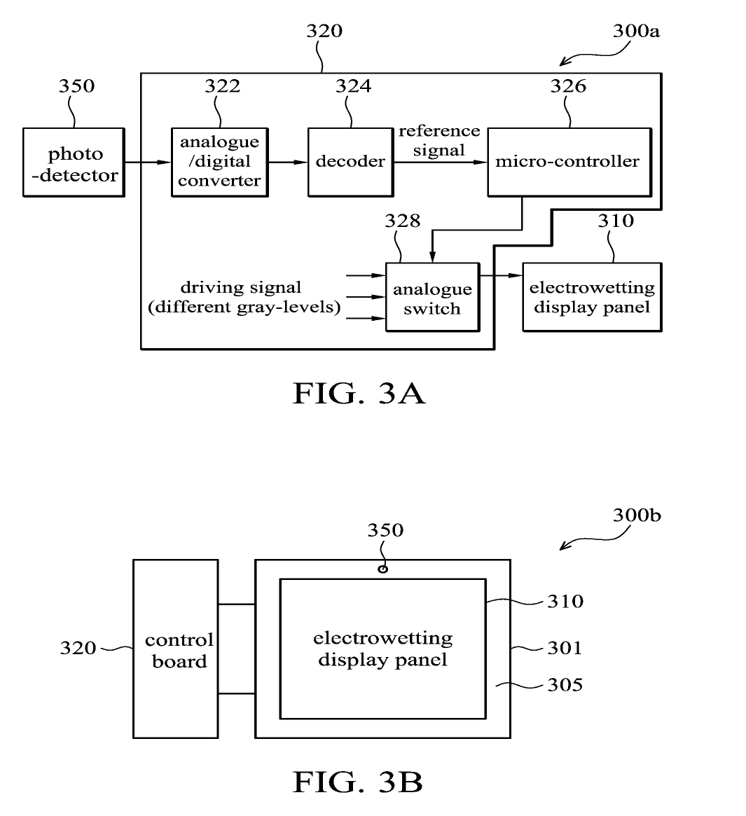

FIGS. 3A and 3B are block diagrams schematically illustrating another embodiment of the smart display device with plug-in photo-detectors. The smart display device with plug-in photo-detectors can convert a measured voltage value into required digital signals through an analog/digital converter (ADC) to achieve modulating light shielding effect when ambient light varies. After a decoding procedure, the digital signals can be optionally transmitted to a micro-controller as a reference signal for controlling an analog switch, however the invention is not limited thereto. Subsequently, suitable driving signals are selected by the analog switch and output to a pixel unit of the electrowetting display panel. The photo-detectors can be disposed on any appropriate location of a frame of the smart display device. A plurality of photo-detectors can be used for more precise detection.

Referring to FIG. 3A, an embodiment of a smart display device 300a includes an electrowetting display panel 310, a control board 320, and a plug-in photo-detector 350. The position and corresponding driving method of the photo-detector 350 are further described as follows. The voltage signal acquired by the photo-detector 350 is converted into a digital signal by an analog/digital converter (ADC) 322. After the digital signal is further decoded by a decoder 324, wherein the invention is not limited thereto, the analog switch 328 is actuated by a micro-controller 326 such that the analog switch 328 outputs an electrical signal for the electrowetting display panel 310.

Referring to FIG. 3B, another embodiment of a smart display device 300b includes a smart display 301 and a control board 320. An electrowetting display panel 310 is disposed at a main region of the smart display 301, and a photo-detector 350 is disposed at a periphery region 305 of the smart display 301.

The photo detective device can be multiple photo-detectors 350 plugging-in a frame of the electrowetting display panel 310. The photo-detectors can be mounted in the structure outside of the electrowetting display panel. The more photo-detectors there are, the more precise the detection results. The panel driving control devices include an analog-to-digital converter to convert a detected voltage to digital signal. The detected data are analyzed and processed by a micro-controller to control an analogue switch. An appropriate analogue driving signal is selected by the micro-controller and transmitted to the electrowetting panel side. The signals detected by the photo-detectors are fed back to the panel driving control device to serve as a reference value. After calculation by the micro-controller, a corresponding voltage is selected and output to the electrowetting panel.

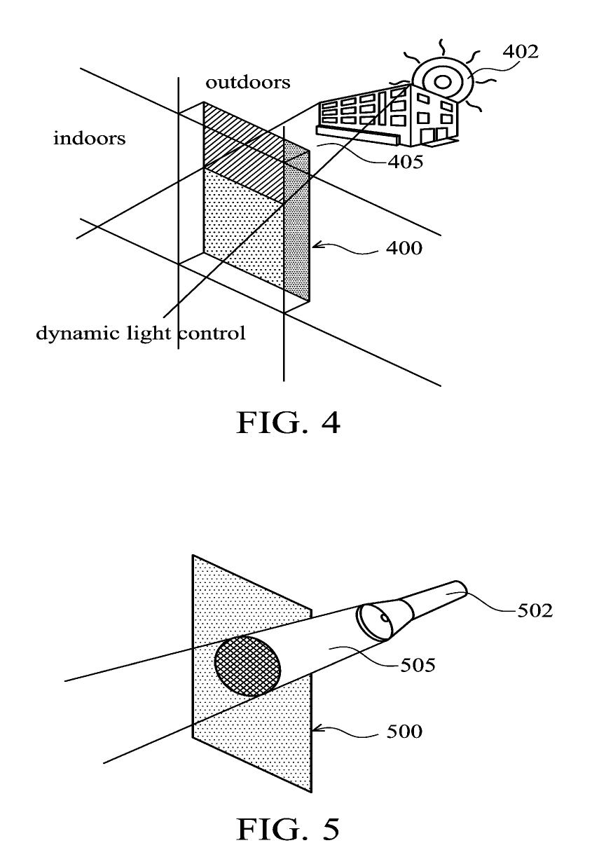

FIG. 4 shows a schematic view of an exemplary embodiment of partially shielding a light-traceable electronic curtain. A local area of the light-traceable electronic curtain 400 can be dynamically controlled (or automatically controlled) to shield out intense ambient light (such as sun light 402) and allow less intense ambient light to pass through other areas.

FIG. 5 shows a schematic view of another exemplary embodiment of partially shielding a light-traceable electronic curtain. Appropriate photo-sensitive materials and circuitry methods are adopted. When intense light 505 (such as torch flash light) is illuminated on a local area of the light-traceable electronic curtain 500, the local area becomes dark. Light tracing effect can thus be achieved. In certain situations, a user's privacy can be protected.

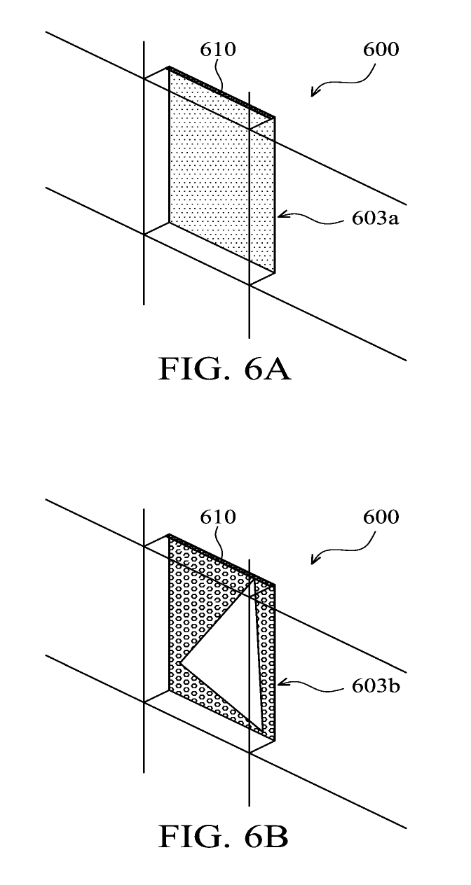

FIGS. 6A and 6B are schematic views illustrating an exemplary embodiment of the smart display device applied as a context window. Different image frames 603a and 603b can be shown in accordance with user settings. Note that in another embodiment the smart display device 600 is installed with a reflective plate 610 unit in reflective mode. Arrangement of the reflective plate can be located at an indoor side or an outdoor side of the smart display device. For use indoors, the reflective plate must be attached on an inner side of the smart display device, and vice versa for use outdoors. Therefore, an additional reflective plate retrieving module is added to the smart display device in one embodiment of the invention corresponding to the reflective mode. One side of the reflective plate is a total reflection surface, while the other side can be printed with advertising information. Therefore, the reflective mode smart display device can thus be applied to large scale displays such as electronic bulletin boards on the billboard of buildings, store showcase advertisements on an indoor information board, and traffic information and advertisements in a bus.

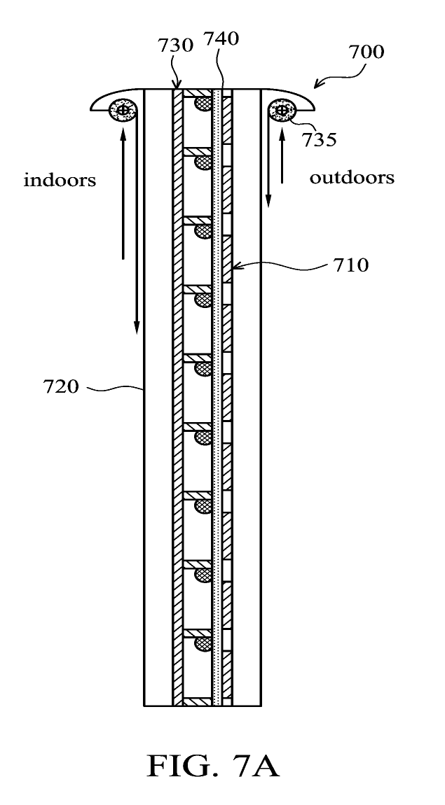

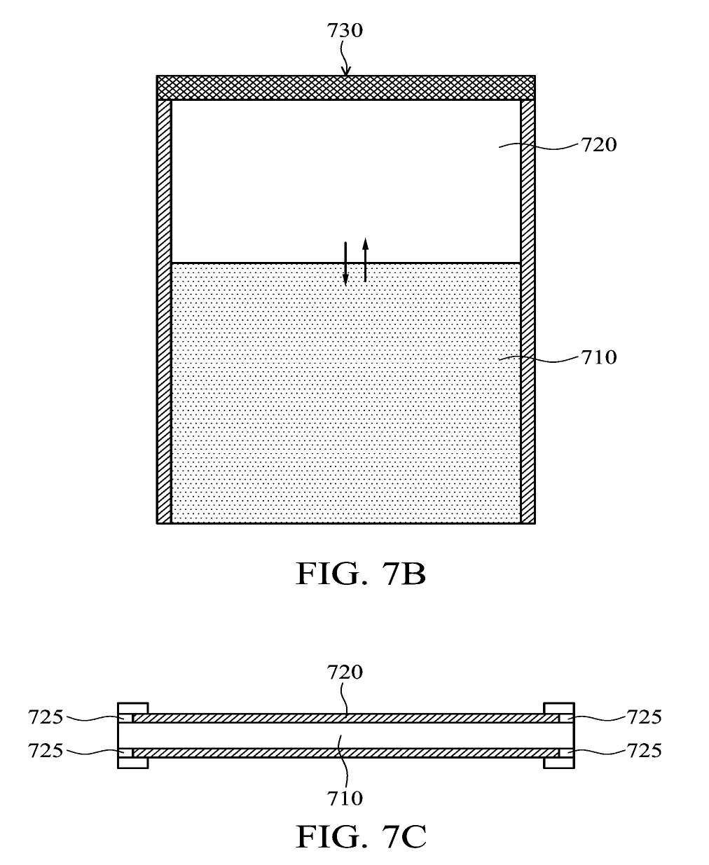

FIGS. 7A to 7C are schematic views illustrating an exemplary embodiment of the smart display device having a double-sided reflective plate structure. FIG. 7A is a side view showing an embodiment of a smart display device 700. In the double-sided reflective display mode, two sets of stretchable reflectors 720 on the inside and outside of the smart display device may be utilized. The double-sided reflector 720 can selectively be scrolled in accordance with practical demand. FIG. 7B is a front view of the smart display device 700. The reflector can be placed close to the display. Other arrangements for the reflector and the electrowetting display panel may be illustrated. FIG. 7C is a top view of the smart display device 700. In one embodiment, a groove structure for guiding the reflector can be disposed on two lateral sides of the display panel. In another embodiment, double-sided grooves 725 can ensure that the reflector plate is attached on the display device 710. More specifically, the smart display device 700 can switch to a reflective type display when the environment light is bright. In order to implement double-sided display effect, a corresponding retrievable reflector mechanism 730 is disposed above both sides of the display device 710. The retrievable reflector mechanism can include a display control system 740, a roller 735, and a reflector plate 720.

Two grooves can be formed on each of the upper and bottom surfaces of the electrowetting panel to guide the retrievable reflector plate so that the reflector plate is attached on the display device. In an exemplary embodiment, a double-sided retrievable reflector mechanism includes a display driving system, retrievable rollers, and a flexible reflector plate. The flexible reflector plate can be made of plastic, metal thin plate, or other suitable materials. The surface of the flexible reflector plate can be a scattered or smooth surface. Some information patterns can be printed and configured by the electrowetting display panel to display information. The retrievable reflector plates can be set on upper and lower sides of the electrowetting display panel. A scrolling mechanism of a scroll curtain is used to switch between a transparent mode display, a reflective mode display, or a printable information display.

In another embodiment, a scroll type double-sided reflector mechanism may include a panel driving control device, retrievable rollers, and a flexible reflector plate. An anti-reflector film can be attached to the retrievable reflector plate.

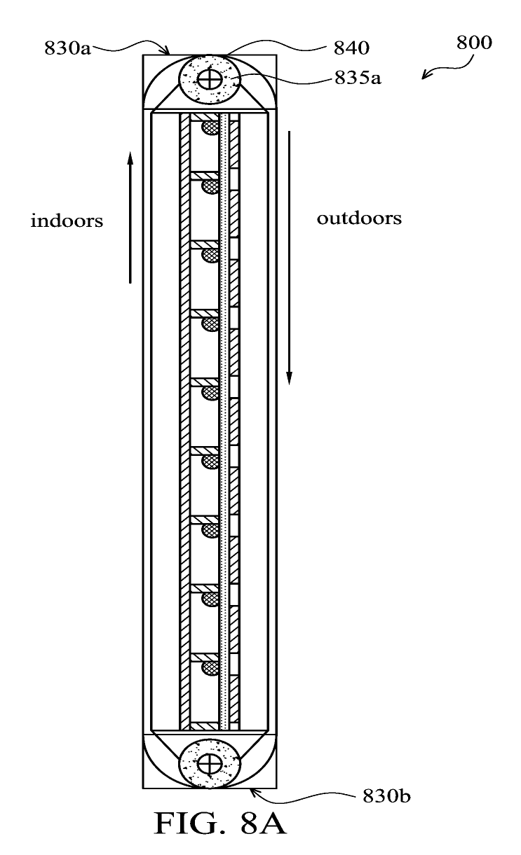

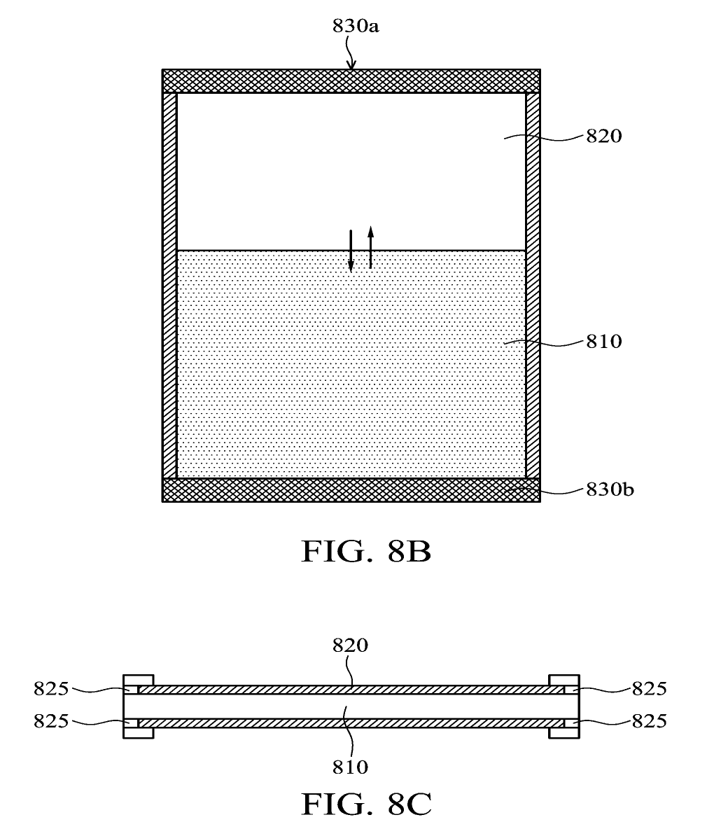

FIGS. 8A to 8C show schematic views of another embodiment of the smart display device with a double-sided retrievable reflector mechanism. FIG. 8A is a side view of the smart display device 800. A display plane is presented by scrolling the curtain on the reflector plate. FIG. 8B is a front view of the smart display device 800 showing arrangement of the scrolling curtain and the retrieving scroll structure. FIG. 8C is a top view of the smart display device 800 showing double sided guiding grooves to ensure that the reflector plate 820 can be attached to the display device 810. The reflector mechanism can not only be an inside/outside separable component, but can also be up/down or left/right retrieving mechanisms 830a and 830b. One side of the retrieving mechanism includes a driving system 840 and the other side includes roller 835a. The scrolling reflector curtain determines the mode, such as the transparent mode or reflective mode of the smart display device.

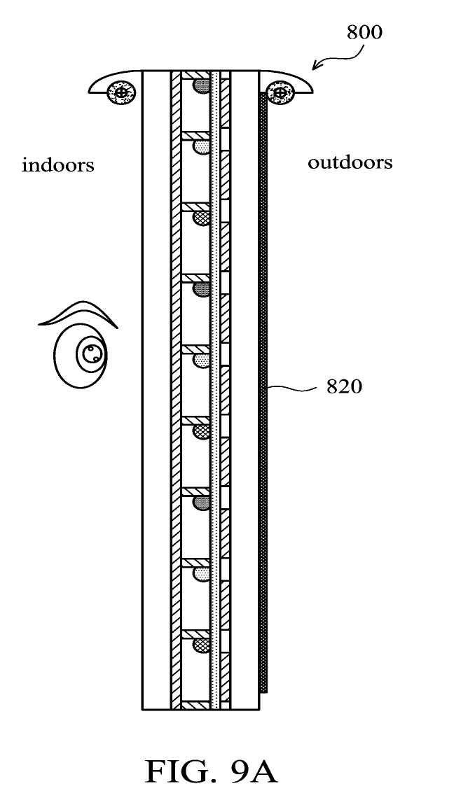

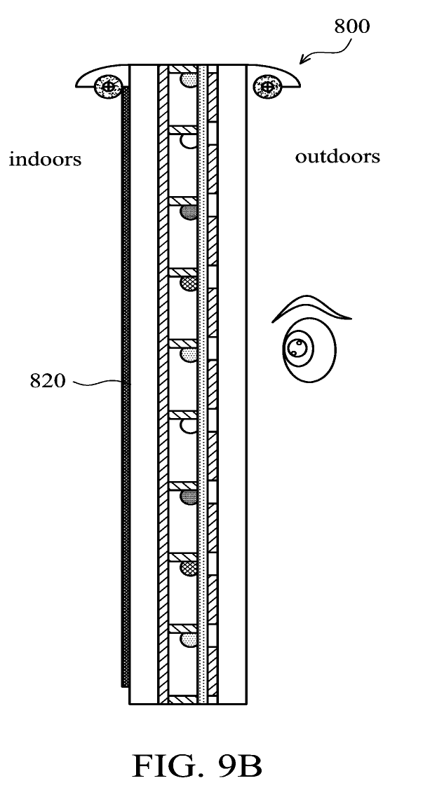

FIGS. 9A and 9B are schematic views illustrating an example of the smart display device of FIG. 8A being applied in a reflective display. FIG. 9A is a schematic view showing an indoor display mode for indoor viewing. When the reflector plate facing outdoors is pulled down, the smart display can be used as an indoor display such as an electronic bulletin board. FIG. 9B is a schematic view showing an outdoor display mode for outdoor viewing. When the reflector plate facing indoors is pulled down, the smart display can be used as an outdoor display such as a large scale electronic billboard. In an embodiment of the invention, when colors of the oils of the electrowetting panel are changed, the reflective mode smart display device can render full color display effect.

Referring to FIG. 9A and FIG. 9B, in the smart display device 800, when colors of the oils of the electrowetting display structure are full colored. Various patterns can be printed on the reflector plate 820 incorporating the color oils to serve as a full color personalized advertisement billboard.

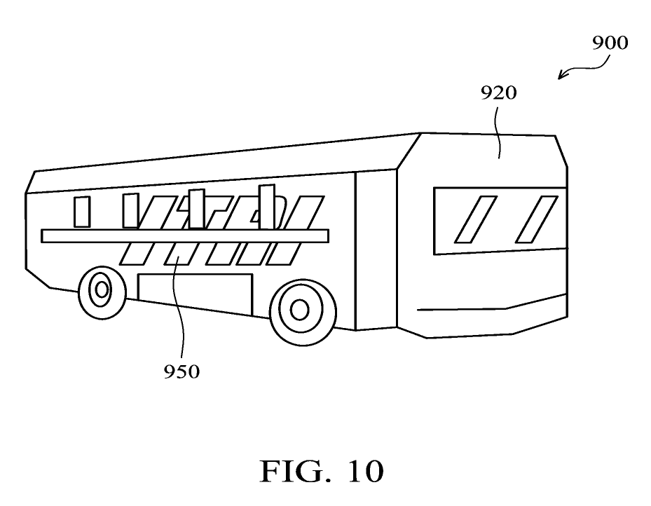

FIG. 10 is a schematic view illustrating another application example of the smart display device of FIG. 8A being applied in a reflective display. In an exemplary embodiment, the smart display device 900 can be used as advertisement billboard 950 on the side of a bus 920 as a public information bulletin.

While the invention has been described by way of example and in terms of the several embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A smart display device, comprising:
an electrowetting panel with an array of multiple pixels, wherein each pixel comprises:
a first substrate and an opposing second substrate with a polar fluid layer and a non-polar fluid layer interposed between the first and second substrates, wherein the non-polar fluid layer directly contacts the first substrate;
a first electrode disposed on the first substrate;
a second electrode disposed on the second substrate; and
a hydrophilic bank structure disposed between the first and the second substrates;
a photo-detector device; and
a panel driving control device,
wherein the photo-detector device detects environmental light such that the electrowetting panel is driven by the panel driving control device accordingly.

2. The smart display device as claimed in claim 1, wherein both the first substrate and the opposing second substrate are assembled through the hydrophilic bank structure blocking the non-polar fluid layer of the multiple pixels.

3. The smart display device as claimed in claim 1, wherein the panel driving control device comprises a set of a first data line and a first scan line electrically connected to a first data driving device and a first scan driving device respectively to drive a pre-determined pixel.

4. The smart display device as claimed in claim 1, wherein the photo-detector device comprises a photo-sensitive material embedded within each pixel.

5. The smart display device as claimed in claim 4, wherein the photo-sensitive material comprises an organic photo-conductor (OPC) or a semiconductor PN junction.

6. The smart display device as claimed in claim 4, wherein the electrowetting panel further comprises an additional set of a second data line and a second scan line electrically connected to a data detective device and a scan detective device respectively to detect a voltage variation or a resist variation of the photo-sensitive material.

7. The smart display device as claimed in claim 4, wherein one photo-sensitive material exists in each pixel.

8. The smart display device as claimed in claim 4, wherein the electrowetting panel comprises a plurality of sub-regions, and wherein several sub-pixels correspond to one photo-sensitive material in each sub-region.

9. The smart display device as claimed in claim 1, wherein the panel driving control device comprises a driving control board and a micro-controller, the electrowetting panel comprises a set of a scan detective line and a data detective line extending to one end of the photo-detector device, and when the photo-detector device is exposed to light and the photo-detector device generates a signal which feeds back to the driving control board, wherein the micro-controller determines a desirable pixel.

10. The smart display device as claimed in claim 1, wherein the photo-detector device comprises a photo-detector externally attached to a frame of the electrowetting panel.

11. The smart display device as claimed in claim 10, wherein the photo-detector is mounted in a structure outside of the electrowetting panel.

12. The smart display device as claimed in claim 1, wherein the panel driving control device comprises an analogue/digital converter transferring a detected voltage during which detected data are recognized through a micro-controller, and an analogue switch is controlled by the micro-controller and used to select suitable analogue driving signals to transmit to the electrowetting panel.

13. The smart display device as claimed in claim 10, wherein a signal detected by the photo-detector device feeds back to the panel driving control device to serve as a reference for calculating a signal and selecting a corresponded voltage to output to the electrowetting panel.

14. A smart display device, comprising:
an electrowetting panel with an array of multiple pixels, wherein each pixel comprises:
a first substrate and an opposing second substrate with a polar fluid layer and a non-polar fluid layer interposed between the first and second substrates, wherein the non-polar fluid layer directly contacts the first substrate;
a first electrode disposed on the first substrate;
a second electrode disposed on the second substrate; and
a hydrophilic bank structure disposed between the first and the second substrates;
a photo-detector device;
a panel driving control device; and
a retrievable reflective plate,
wherein the photo-detector device detects environmental light such that the electrowetting panel is driven by the panel driving control device accordingly, and
wherein the retrievable reflective plate is a double layered reflective plate respectively set on both sides of the electrowetting panel.

15. The smart display device as claimed in claim 14, wherein both the first substrate and the opposing second substrate are assembled through the hydrophilic bank structure blocking the non-polar fluid layer of the multiple pixels.

16. The smart display device as claimed in claim 14, wherein the panel driving control device comprises a set of a first data line and a first scan line electrically connected to a first data driving device and a first scan driving device respectively to drive a pre-determined pixel.

17. The smart display device as claimed in claim 14, wherein the photo-detector device comprises a photo-sensitive material embedded within each pixel.

18. The smart display device as claimed in claim 17, wherein the photo-sensitive material comprises an organic photo-conductor (OPC) or a semiconductor PN junction.

19. The smart display device as claimed in claim 17, wherein the electrowetting panel further comprises an additional set of a second data line and a second scan line electrically connected to a data detective device and a scan detective device respectively to detect a voltage variation or a resist variation of the photo-sensitive material.

20. The smart display device as claimed in claim 17, wherein merely one photo-sensitive material exists in each pixel.

21. The smart display device as claimed in claim 17, wherein the electrowetting panel comprises a plurality of sub-regions, and wherein several sub-pixels correspond to one photo-sensitive material in each sub-region.

22. The smart display device as claimed in claim 14, wherein the panel driving control device comprises a driving control board and a micro-controller, the electrowetting panel comprises a set of a scan detective line and a data detective line extending to one end of the photo-detector device, and when the photo-detector device is exposed under light and a signal is generated by the photo-detector device which feeds back to the driving control board and determines a desirable pixel through the micro-controller.

23. The smart display device as claimed in claim 14, wherein the photo-detector device comprises a photo-detector externally attached to a frame of the electrowetting panel.

24. The smart display device as claimed in claim 23, wherein the photo-detector is mounted in a structure outside the electrowetting panel.

25. The smart display device as claimed in claim 14, wherein the panel driving control device comprises an analogue/digital converter transferring a detected voltage during which detected data are recognized through a micro-controller, and an analogue switch is controlled by the micro-controller and used to select suitable analogue driving signals to transmit to the electrowetting panel.

26. The smart display device as claimed in claim 23, wherein a signal detected by the photo-detector device feeds back to the panel driving control device to serve as a reference for calculating a signal and selecting a corresponded voltage to output to the electrowetting panel.

27. The smart display device as claimed in claim 14, wherein a groove is disposed on each of the upper and lower surfaces of the electrowetting panel to guide the retrievable reflective plate such that the retrievable reflective plate flatly attaches to the electrowetting panel when spread.

28. The smart display device as claimed in claim 14, wherein the retrievable reflective plate is a double-sided mechanism comprising a panel driving system, a retrieve roller, and a flexible reflector.

29. The smart display device as claimed in claim 28, wherein the flexible reflector comprises a plastic and a metal thin plate.

30. The smart display device as claimed in claim 14, wherein a surface of the flexible reflector comprises a scattering plane or a smooth plane surface.

31. The smart display device as claimed in claim 30, wherein the retrievable reflective plate is set on an upper end or a lower end of the electrowetting panel thereby switching between a transparent mode, a reflection mode, and a printing information mode by a scrolling mechanism of a scroll curtain.

32. The smart display device as claimed in claim 14, further comprising a scroll type double sided reflector mechanism comprising the panel driving control device, a retrievable roller, and a flexible reflector.

33. The smart display device as claimed in claim 14, wherein an anti-reflective film is attached to a surface of the retrievable reflective plate.
